(19) United States
(12) Patent Application Publication
(10) Pub. No.: US 2011/0179928 A1
(43) Pub. Date: Jul. 28, 2011

(54) Automatic display device use for scale of saw blade

(76) Inventor: Tian Wang Wang, Taichung Hsien (TW)

(21) Appl. No.: 12/622,430

(22) Filed: Jan. 27, 2010

(51) Int. Cl. B26D 7/27

(52) U.S. Cl. 83/522.17

(57) ABSTRACT

An automatic display device use for scale of saw blade comprising a base including a seat having a vertical moving member mounted on a lower side thereof to receive a saw blade, two brackets disposed on two sides thereof respectively, and a coupling piece fixed on one end thereof, the coupling piece including a retaining projection secured on an outer side thereof; a levering device installed to the bracket by using a positioning member and including a support shaft to connect with a lateral shank including an elongated slot arranged on a front end and a third auxiliary wheel disposed on a rear end; a turning pedestal disposed on an inner side of the base and including a second auxiliary wheel; a scale wheel including a returning spring fixed therein; a steel rope including two ends to connect with the scale wheel and the vertical moving member.

### BACKGROUND OF THE INVENTION

1. Field of the Invention

The present invention relates to an automatic display device use for scale of saw blade that when the saw blade is at a tilted angle, a vertical size at the highest point of the saw blade is measured and displayed precisely.

2. Description of the Prior Art

A conventional display device use for scale of saw blade is operated by a user to move vertically to control a height of the displaying scale of the scale wheel to be identified clearly.

However, as such a conventional display device use for scale of saw blade is used in cutting process, the saw blade has to be adjusted to become tilted, but its display device can not be adjusted to become tilted simultaneously.

The present invention has arisen to mitigate and/or obviate the afore-described disadvantages.

### SUMMARY OF THE INVENTION

The primary object of the present invention is to provide an automatic display device use for scale of saw blade that when the saw blade is at a tilted angle, a vertical size at the highest point of the saw blade is measured and displayed precisely.

An automatic display device use for scale of saw blade in accordance with a preferred embodiment of the present invention comprising a base including:

a seat having a vertical moving member mounted on a lower side thereof to receive a saw blade, two brackets disposed on two sides thereof respectively, and a coupling piece fixed on one end thereof, the coupling piece including a retaining projection secured on an outer side thereof;

a levering device installed to the bracket by using a positioning member, and including a support shaft to connect with a lateral shank, the lateral shank including an elongated slot arranged on a front end thereof and a third auxiliary wheel disposed on a rear end thereof;

a turning pedestal disposed on an inner side of the base and including a second auxiliary wheel;

a scale wheel including a returning spring fixed therein; a steel rope including two ends to connect with the scale wheel and the vertical moving member of the saw blade.

### BRIEF DESCRIPTION OF THE DRAWINGS

FIG. 1 is a perspective view showing the assembly of an automatic display device use for scale of saw blade according to a preferred embodiment of the present invention;

FIG. 2 is a perspective view showing the inner structure of the automatic display device use for scale of saw blade according to the preferred embodiment of the present invention;

FIG. 3-1 is a perspective view showing the exploded components of a scale wheel of the present invention;

FIG. 3-2 is a perspective view showing the assembly of the scale wheel of the present, invention;

FIG. 4 is another perspective view showing the inner structure of the automatic display device use for scale of saw blade according to the preferred embodiment of the present invention;

FIG. 5 is a perspective view showing the assembly of a levering device of the automatic display device use for scale of saw blade according to the preferred embodiment of the present invention;

FIG. 6A is a partial amplified view showing the assembly of the levering device of the automatic display device use for scale of saw blade according to the preferred embodiment of the present invention;

FIG. 7 is a cross sectional view of a saw blade and a steel rope of the automatic display device use for scale of saw blade according to the preferred embodiment of the present invention;

FIG. 8 is another cross, sectional view of the saw blade and the steel rope of the automatic display device use for scale of saw blade according to the preferred embodiment of the present invention;

FIG. 9 is a perspective view showing the operation of the automatic display device use for scale of saw blade according to the preferred embodiment of the present invention;

FIG. 10 is a plan view showing the operation of the levering device of the automatic display device use for scale of saw blade according to the preferred embodiment of the present invention;

FIG. 11 is another plan view showing the operation of the levering device of the automatic display device use for scale of saw blade according to the preferred embodiment of the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

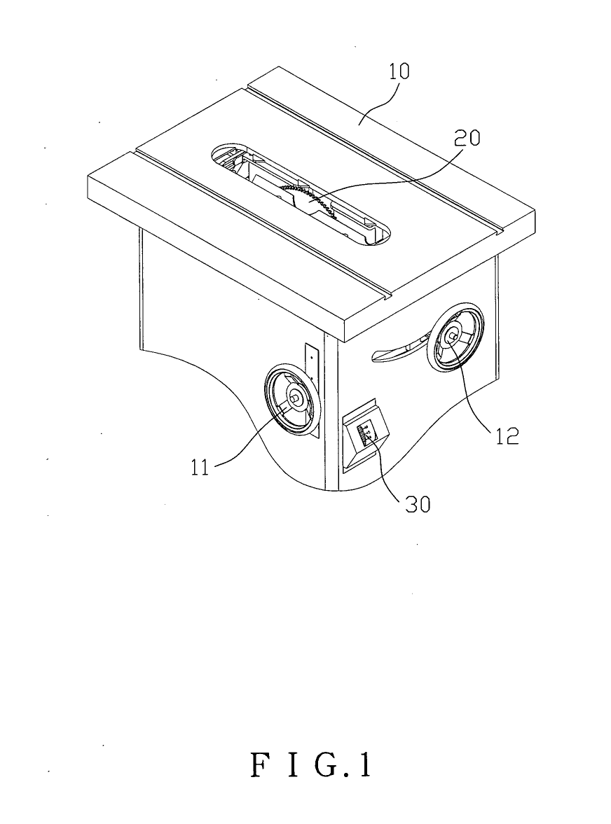

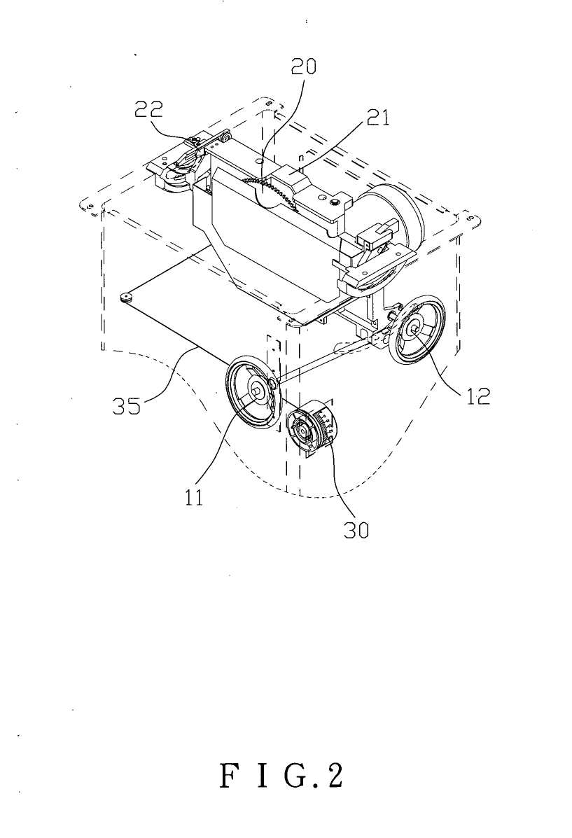

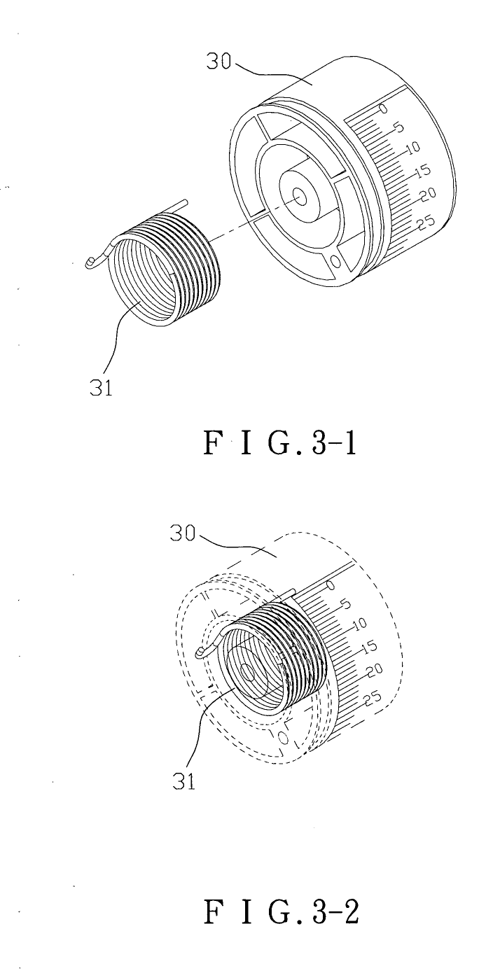

Referring to FIGS. 1 and 2, an automatic display device use for scale of saw blade in accordance with a preferred embodiment of the present invention comprises a base 10 including a saw blade 20 disposed on a top end thereof, including a second control member 12 and a scale wheel 30 mounted on one end thereof, including a first control member 11 fixed on a front side thereof, the base 10 also including a seat 21 having a vertical moving member (not shown) secured therein to fix the saw blade 20, and the seat 21 has two brackets 23 attached on two sides thereof respectively, and has a coupling piece 22 formed between the seat 21 and the bracket 23. As shown in FIGS. 3-1, 3-2 and 4, a scale wheel 30 is connected with a steel rope 35 and includes a returning spring 31 disposed therein to pull the steel rope 35 backward.

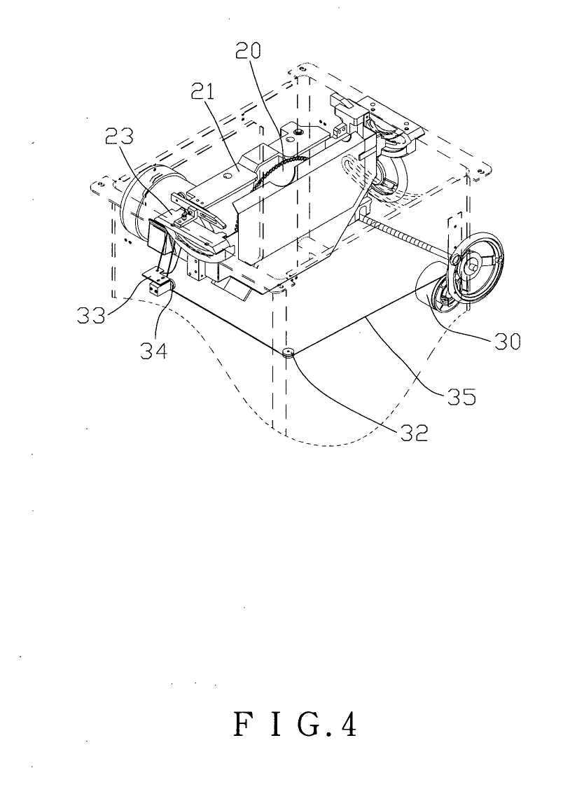

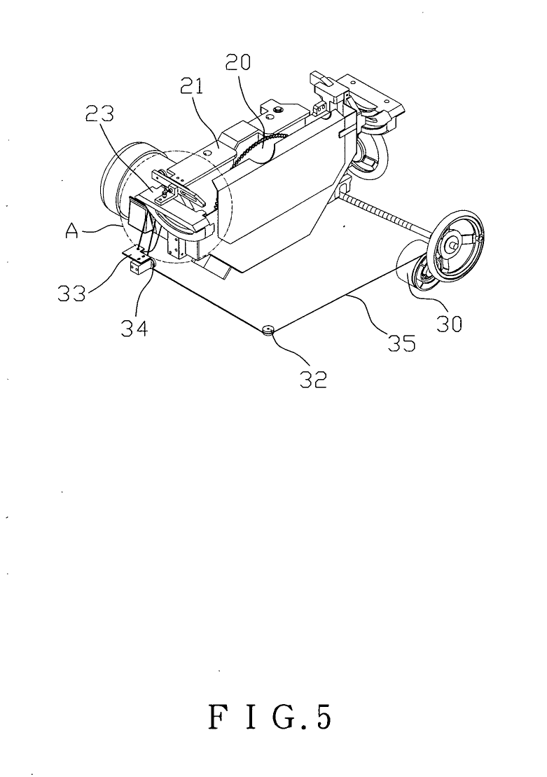

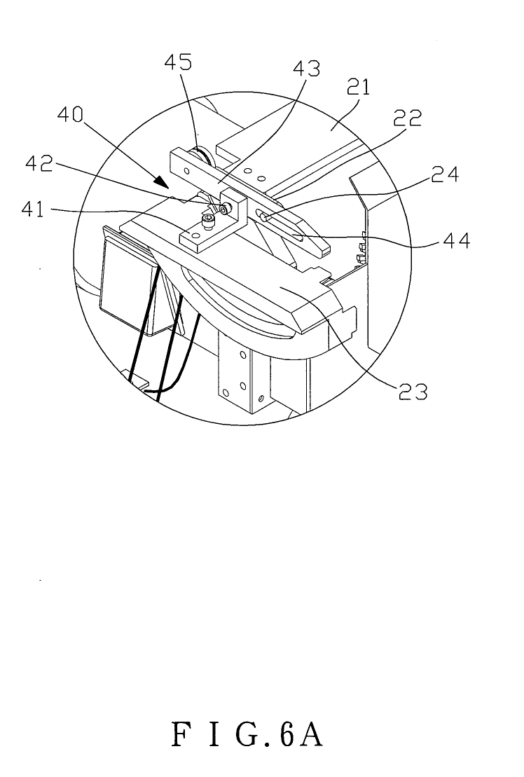

Referring further to FIGS. 4-6A, the bracket 23 of the seat 21 includes a positioning member 41 having a support shaft 42 to connect with a lateral shank 43, and the lateral shank 43 includes an elongated slot 44 arranged on a front end thereof, and includes a third auxiliary wheel 45 disposed on a rear end thereof to form a levering device 40, and the slot 44 includes a retaining projection 24 extending out of the coupling piece 22 of the seat 21. The steel rope 35 extends through a first auxiliary wheel 32 of the base 10 to couple to a second auxiliary wheel 34 of a turning pedestal 33 and then extends through the third auxiliary wheel 45 of the levering device 40 and the turning pedestal 33 to couple with the vertical moving member (not shown) of the saw blade 20, hence two ends of the steel rope 35 are in connection with the scale wheel 30 and the vertical moving member (not shown) of the saw blade 20 individually.

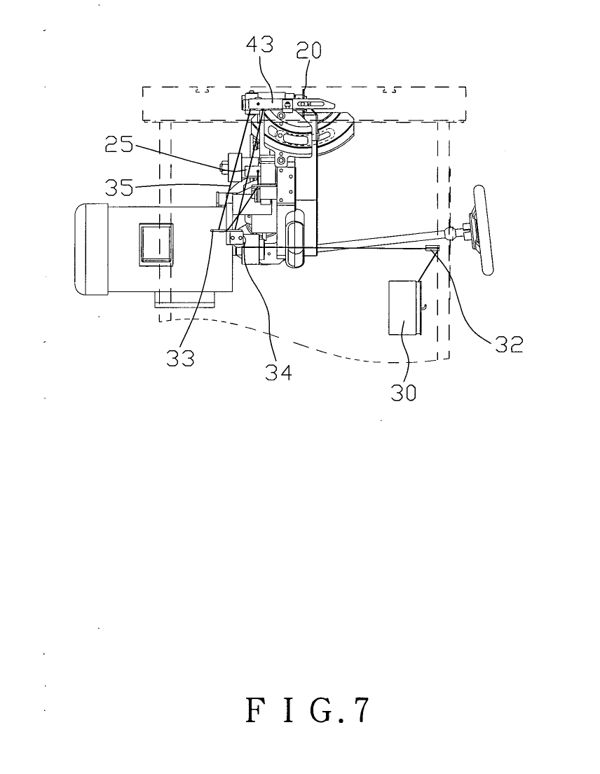

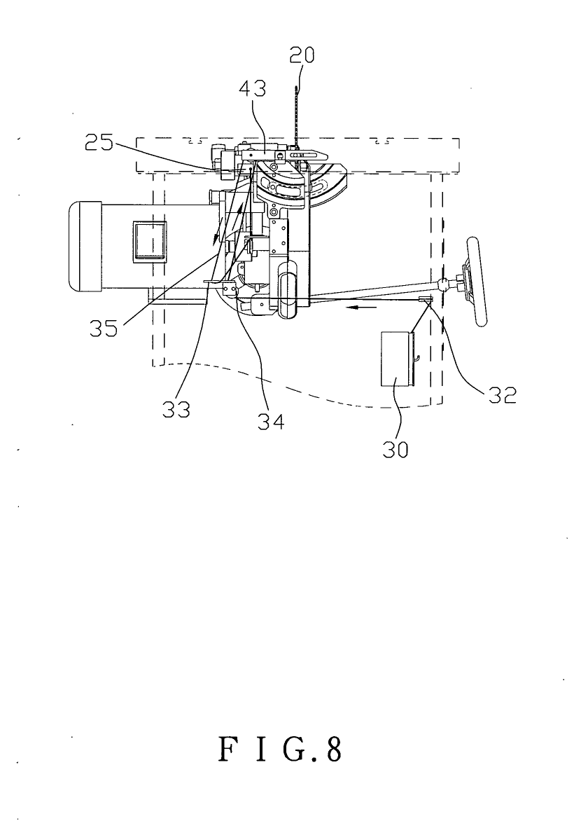

As illustrated in FIGS. 7 and 8, as the saw blade 20 is operated to be in a vertical state, the lateral shank 43 of the levering device 40 is in a horizontal state, and when the saw blade 20 moves upward by using the vertical moving member 25, the steel rope 35 is actuated to extend outward to pull the scale wheel 30 to rotate, thus indicating a height of the saw blade 20.

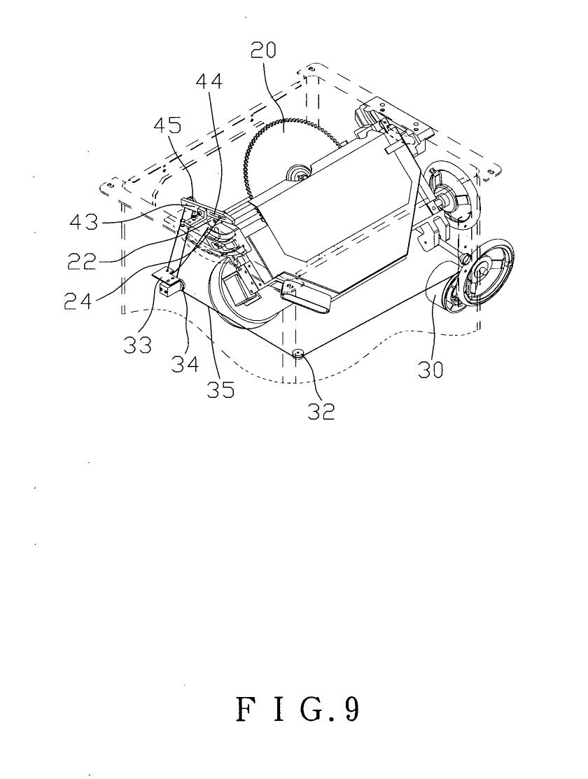

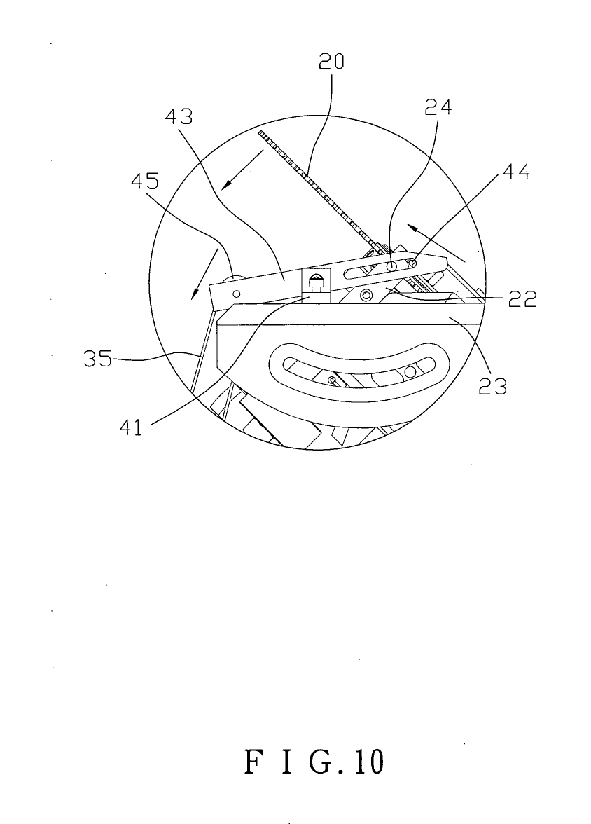

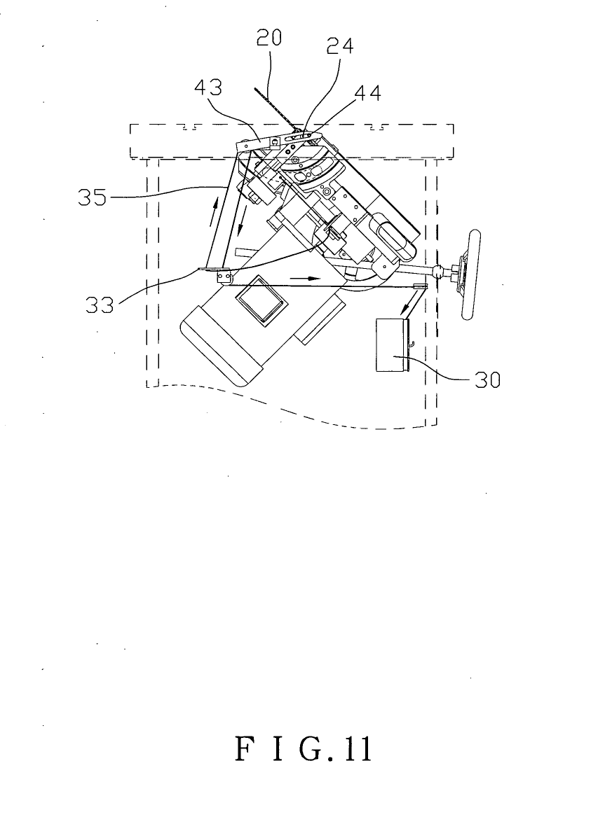

With reference to FIGS. 9-11, when the saw blade 20 is in a tilted state, the seat 21 becomes tilted so that the retaining projection 24 of the lateral shank 43 moves in the slot 44 and pushes an end portion of the lateral shank 43 to turn upward, hence the support shaft 42 becomes a rotating center and the third auxiliary wheel 45 of the lateral shank 43 moves downward, such that a height of the third auxiliary wheel 45 decrease so that the steel rope 35 moves toward the scale wheel 30. Thereby, when the saw blade 20 is at a tilted angle, a vertical size at the highest point of the saw blade 20 is measured and displayed precisly.

While we have shown and described various embodiments in accordance with the present invention, it is clear to those skilled in the art that further embodiments may be made without departing from the scope of the present invention.

What is claimed is:

1. An automatic display device use for scale of saw blade comprising a base including:
a seat having a vertical moving member mounted on a lower side thereof to receive a saw blade, two brackets disposed on two sides thereof respectively, and a coupling piece fixed on one end thereof, the coupling piece including a retaining projection secured on an outer side thereof;
a levering device installed to the bracket by using a positioning member, and including a support shaft to connect with a lateral shank, the lateral shank including an elongated slot arranged on a front end thereof and a third auxiliary wheel disposed on a rear end thereof;
a turning pedestal disposed on an inner side of the base and including a second auxiliary wheel;
a scale wheel including a returning spring fixed therein;
a steel rope including two ends to connect with the scale wheel and the vertical moving member of the saw blade.

2. The automatic display device use for scale of saw blade as claimed in claim 1, wherein the returning spring of the scale wheel allows to pull the steel rope to move backward.

3. The automatic display device use for scale of saw blade as claimed in claim 1, wherein the steel rope extends through a first auxiliary wheel of the base to couple to the second auxiliary wheel of the turning pedestal and then extends through the third auxiliary wheel of the levering device and the turning pedestal to couple with the vertical moving member of the saw blade.

4. The automatic display device use for scale of saw blade as claimed in claim 1, wherein when the saw blade is in an operating state, the lateral shank of the levering device is in a horizontal state.
